(19) United States
(12) Patent Application Publication
(10) Pub. No.: US 2019/0264897 A1
(43) Pub. Date: Aug. 29, 2019

(54) MAGNETIC MOUNTING ASSEMBLY FOR AN UNDER-CABINET LED LIGHT FIXTURE

(71) Applicant: ETi Solid State Lighting Inc., Vernon Hills, IL (US)

(72) Inventors: Gary Van Winkle, Chagrin Falls, OH (US); William Carter, Brooks, GA (US); Kerby Siglin, Kennesaw, GA (US)

(73) Assignee: ETi Solid State Lighting Inc., Vernon Hills, IL (US)

(21) Appl. No.: 16/286,663

(22) Filed: Feb. 27, 2019

Related U.S. Application Data
(60) Provisional application No. 62/635,790, filed on Feb. 27, 2018.

(51) Int. Cl. F21V 21/096

(52) U.S. Cl. CPC F21V 21/096; F21Y 2115/10

(57) ABSTRACT

A mounting assembly for an under-cabinet LED light fixture comprises in one embodiment a ferromagnetic mounting plate or bar for being securable to the upper wall of the under-cabinet, and the LED light fixture has a topside to which is attached one or more permanent magnetics. The one or more magnets attached to the topside are magnetically attracted to the mounting plate to attach the under-cabinet light fixture to the mounting plate. In another embodiment, the mounting plate is a magnet, and the under-cabinet LED light fixture has one or more ferromagnetic portions for being attached to the mounting plate by magnetic attraction.

### CROSS-REFERENCE TO RELATED APPLICATION

This application claims priority of U.S. Provisional Application No. 62/635,790 filed Feb. 27, 2018, which is incorporated herein by reference in its entirety.

### BACKGROUND OF THE INVENTION

### Field of the Invention

This invention relates to the mounting of light fixtures, and in particular to the mounting of LED light fixtures inside of under-cabinets in which the LED light fixture will provide illumination. The invention is most particularly related to the mounting of elongated, under-cabinet LED light fixtures, although as explained below, the inventive mounting device could be used for other types of LED light fixtures as well.

### Description of the Prior Art

Under-cabinet light fixtures are well known in the art. There are many types of under-cabinet light fixtures which are currently in use, and these include fluorescent fixtures, xenon fixture, hard wire or plug fixtures, LED light strips and LED plug lights. However, LED light fixtures and LED light bars are increasing in popularity. LED fixtures are often elongated. LED light fixtures that are elongated are widely used because they provide extensive illumination and have extremely long lives. Some well-known light fixtures presently on the market are those produced by ETi Solid State Lighting, Inc. (“ETi”), and one is shown in FIG. 5. ETi under-cabinet light fixtures currently available are designated as, respectively, 9″ under-cabinet, 12″ under-cabinet, 18″ under-cabinet and 24″ under-cabinet. Other under-cabinet LED light fixtures are produced by General Electric and other well-known brands.

Traditionally, the mounting of hard wire or plug-in under-cabinet lights has been a cumbersome, time consuming and tedious job. According to one well-known procedure, it is first necessary to run cables for the under-cabinet light fixture. This involves the steps of turning off all power to the cabinet location in order to prevent any electrical shocks. It is then necessary to determine how much wiring is needed for the light fixture or fixtures, and as many holes as are necessary in which the electric wires are to be inserted must be provided. If the countertop above the cabinet has a backsplash that is removable, it must be removed and a channel must be cut in the drywall or plaster that will be covered by the backsplash. Holes must be drilled in the studs to accommodate the cable. If the backsplash cannot be removed, enough time must be permitted to enable the patching and painting of the wall after the installation of the wire. Alternatively, tiles can be installed between the countertop and the wall cabinets.

In addition, each under-cabinet light must be examined to determine exactly where the cable will enter and exit from the under-cabinet light. Holes must then be cut in the wall where the cable will enter the under-cabinet light. These cuts must be made carefully so the hole will be covered when the under-cabinet light is installed.

It is necessary to cut a hole in the wall for the switchbox, and to run a cable to the switchbox from a power source which could be a receptacle in the vicinity of the switchbox. A cable is then run from the switchbox to the hole in the wall for the first light, then from the first light to the second light, etc. Thereafter, the light fixture must be disassembled, and the lens of the light fixture must be removed. Each cable to the light fixture must be clamped to the light fixture. It is necessary to have an assistant hold the light fixture as close to the rear wall as possible so that screws can be driven through the light fixture into the underside of the cabinet. Care must be taken so that the screws do not extend through to the inside of the cabinet.

It is then necessary to install a switchbox having the cables clamped to the switchbox. The ground wire must then be run to switch and tape is used to cover the terminals. The foregoing is needed with the cable is inside the cabinet. When the cable is under the cabinet, lights are attached under the cabinets, cable is strung under the cabinets and the cable is then stapled in place against the wall of the cabinet.

In order to install elongated LED under-cabinet light fixtures that are not hard wired and a receptacle is available, installation is easier, but still requires cumbersome work and requires several hand tools. In general, holes must be drilled in the upper wall of the under-cabinet to be aligned with screw holes in the elongated LED under-cabinet light fixtures. Thereafter, appropriate screws must be installed through the screw holes and into the drill holes in the upper wall of the under-cabinet. If the holes are not properly made, the process may have to be repeated.

### BRIEF SUMMARY OF THE INVENTION

An object of the present invention is to provide an easy to use apparatus for attaching an under-cabinet LED light fixture to the upper wall of the under-cabinet for illumination of the under-cabinet.

Another object of the present invention is to provide a mounting assembly which can be installed to the upper wall of an under-cabinet requiring a few, easy to use components.

It is an additional object of the present invention to provide an assembly apparatus which requires little skill and little expertise to install an under-cabinet mounting structure to which an under-cabinet LED light can be mounted.

A further object is to provide an under-cabinet assembly apparatus that can permit adjustment of an under-cabinet LED light fixture without requiring reinstallment of the mounting assembly.

These and other objects will be apparent from the description to follow and from the appended claims.

### BRIEF DESCRIPTION OF THE DRAWINGS

FIG. 1 is a front view of a cabinet as shown in FIG. 1, with drywall anchors installed therein.

FIG. 2 shows in perspective a mounting plate for a preferred embodiment of the invention.

FIG. 3 is an enlarged detailed perspective view of a portion of the mounting plate with a screw with an O-ring thereon installed in openings installed in the mounting plate.

FIG. 4 is a side, cross-sectional view of a mounting plate being installed in the upper wall of an under-cabinet.

FIG. 5 is a side, cross-sectional view showing a mounting plate properly installed on the upper wall of an under-cabinet, with an LED light fixture about to be attached to the mounting plate by means of magnetic attraction pursuant to a preferred embodiment of the invention.

FIG. 6 is a top plan view of an LED light fixture according to a preferred embodiment of the invention.

FIG. 7 is a side view of an LED light fixture according to the invention about to be installed directly in an under-cabinet, with a detailed enlargement of an O-ring attached to a mounting screw.

FIG. 8 is a side view of the LED light fixture shown in FIGS. 6 and 7 installed directly in an under-cabinet by means of a power tool.

FIG. 9 is a side view of the LED light fixture shown in FIGS. 6-8 with an enlarged detail of the power-in end of the LED light fixture with an end cap removed for receiving an electric power cord to transmit electrical power.

FIG. 10 is a perspective view of the LED light fixture shown in FIGS. 6-9 about to be connected with a power cord.

FIG. 11 is a perspective view of a power cord with clips for attachment to an under cabinet.

FIGS. 12-13 are perspective views of an LED light fixture as shown in FIGS. 6-10 wherein direct wire power connections are being made.

FIGS. 14-16 are perspective views of apparatus used for making wire power connections with an LED light fixture as shown in FIGS. 6-10 and 12-13.

### DETAILED DESCRIPTION OF THE PREFERRED EMBODIMENT

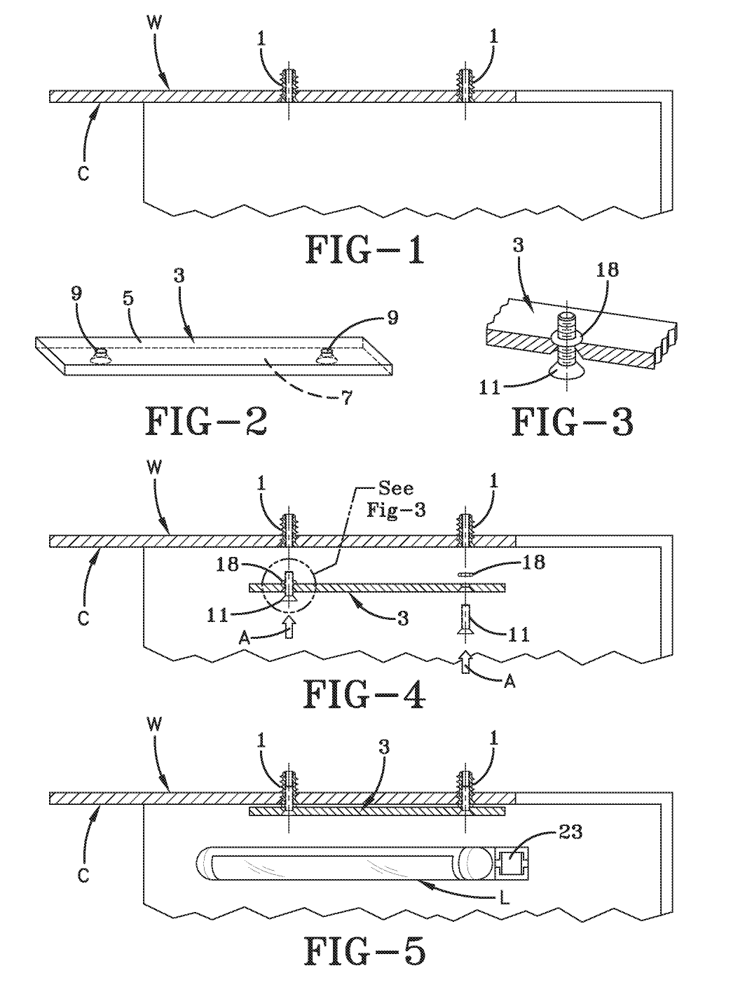

Referring first to FIG. 1, which is a front view of a cabinet C in which an under-cabinet LED light fixture L (shown in FIG. 5) is to be installed. Cabinet C has an upper wall W to which under-cabinet LED light fixture L is to be attached. A pair of drywall anchors 1 extend upwardly on the upper surface of the upper cabinet wall W, into which drywall anchors 1 are inserted through holes that have been drilled and tapped, and through which drywall anchors 1 are inserted.

FIG. 2 shows a mounting plate 3. Mounting plate 3 in one embodiment is made of a magnetic metal to which magnetic attraction can be made. Magnetic metals include iron, nickel and cobalt. Since steel consists mostly of iron, steel also is magnetic. Alternatively, in another embodiment, mounting plate 3 could be a magnet itself, or could have one or more magnets as attached to an underside 7 of mounting plate 3. Mounting plate 2 has a topside 5.

Mounting plate 3 has a set of holes 9 for receiving respective screws 11. Each screw 11 is provided with an O-ring 18 as shown in FIG. 3. Referring to FIG. 4, screws 11, having been inserted through holes 9 in mounting plate 3, are screwed through the holes which are located to lead to drywall anchors 1. Arrows A indicate the direction of movement of screws 11 and mounting plate 3 as screws 11 are driven into drywall anchors 1. This will be explained in further detail below.

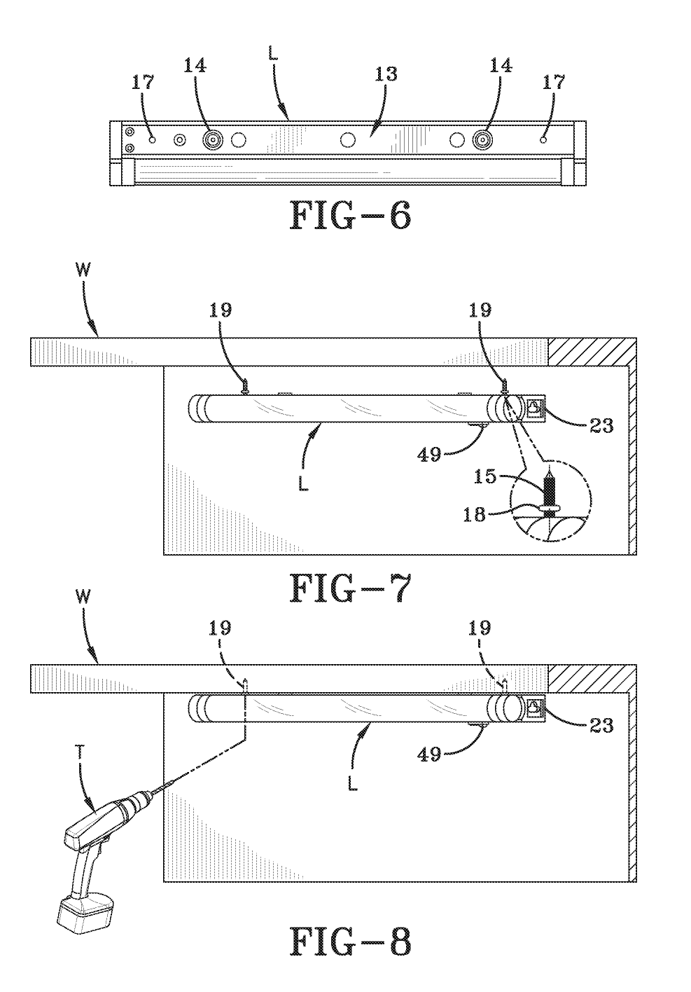

FIG. 5 illustrates under-cabinet LED light fixture L about to be attached directly to mounting plate 3. Under-cabinet LED light L has a back plate 13 (FIG. 6) upon which have been attached one or more magnets 14, and in the preferred embodiment there are two magnets 14. This can be seen in FIG. 6. FIG. 6 is a top plan view of light fixture L. Light fixture L is shown as having two magnets 14 spaced inwardly towards each other from the opposite ends of light fixtures L. Magnets 14 are strong enough to be attracted to mounting plate 3 and to hold LED light fixture L against mounting plate 3 due to magnetic attraction.

As mentioned earlier, mounting plate 3 could be a magnet itself or have magnets attached thereto, in which case back plate 13 of under-cabinet LED light fixture L could be made of a magnetic material or could be a magnet itself and would be magnetically attached to mounting plate 3 and held there in place.

The method of installing the under-cabinet LED light fixture L to the direct underside of the cabinet having wall W is shown in FIGS. 7 and 8. A pair of mounting screws 15 are inserted into holes 17 (FIG. 6), and onto which are attached an O-ring 18. Then, while holding LED light fixture L up to wall W, and matching the location of mounting screws 19 to locations previously marked on the underside of wall W, a power tool T is used to tighten mounting screws 19 on each end of LED light fixture L. This is thus a way of attaching LED light fixture L to cabinet C without making use of magnets 14.

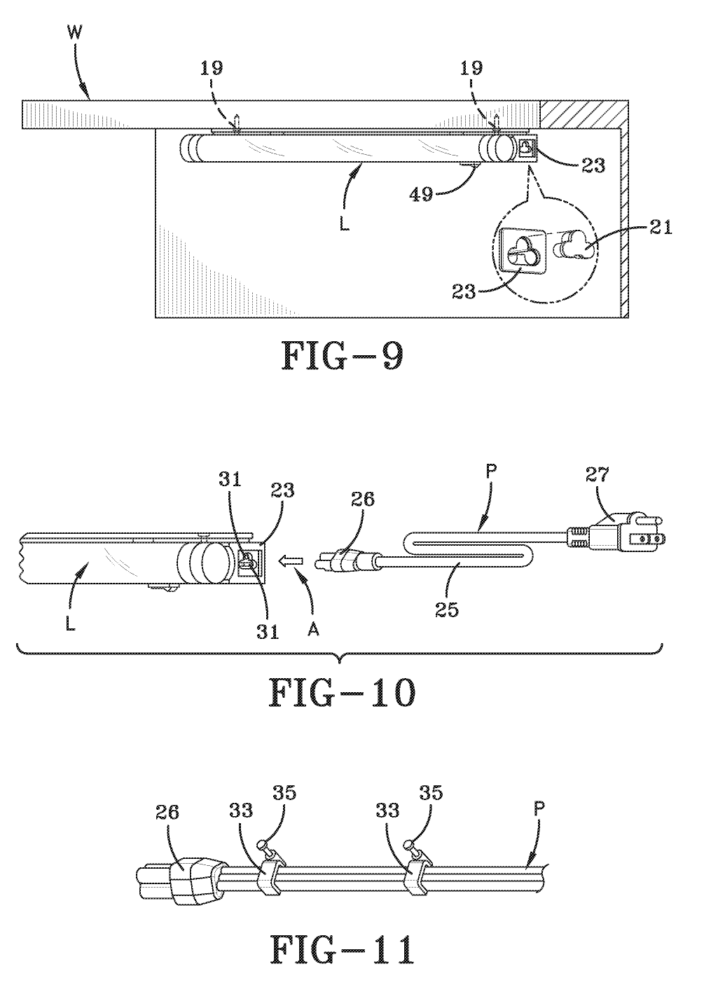

FIGS. 10-11 indicate how power is suppled to LED light fixture L, and FIGS. 7-10 show a “power-in” end 23 of LED light fixture L. In order to connect a power cord P to LED light fixture L, an end cap 21 is removed from power-in end 23. FIG. 9 includes a detail view of end cap 21 and power-in end 23. Power cord P includes an electric wire 25 having a plug 27 for insertion into a power cord receptacle. A three-pronged female connecting device 26 is inserted into power-end 23 which receives prongs 31 located in power-end 23.

It is also possible to connect power cord P to the underside of cabinet C incorporating wall W by means of wire clips 33. Wire clips 33 are attachable to the underside of cabinet wall W by means of a pair of respective screws 35.

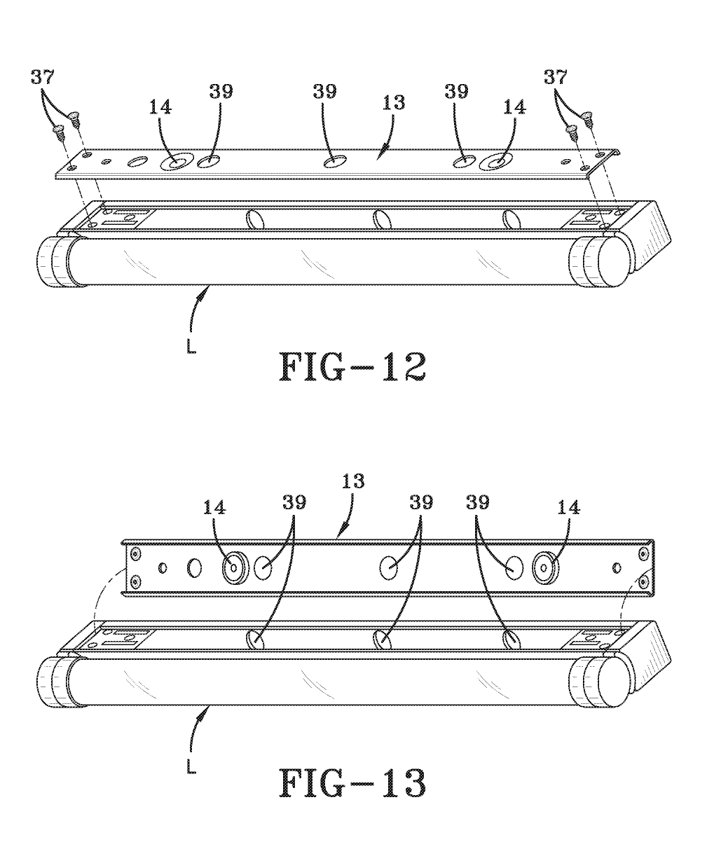

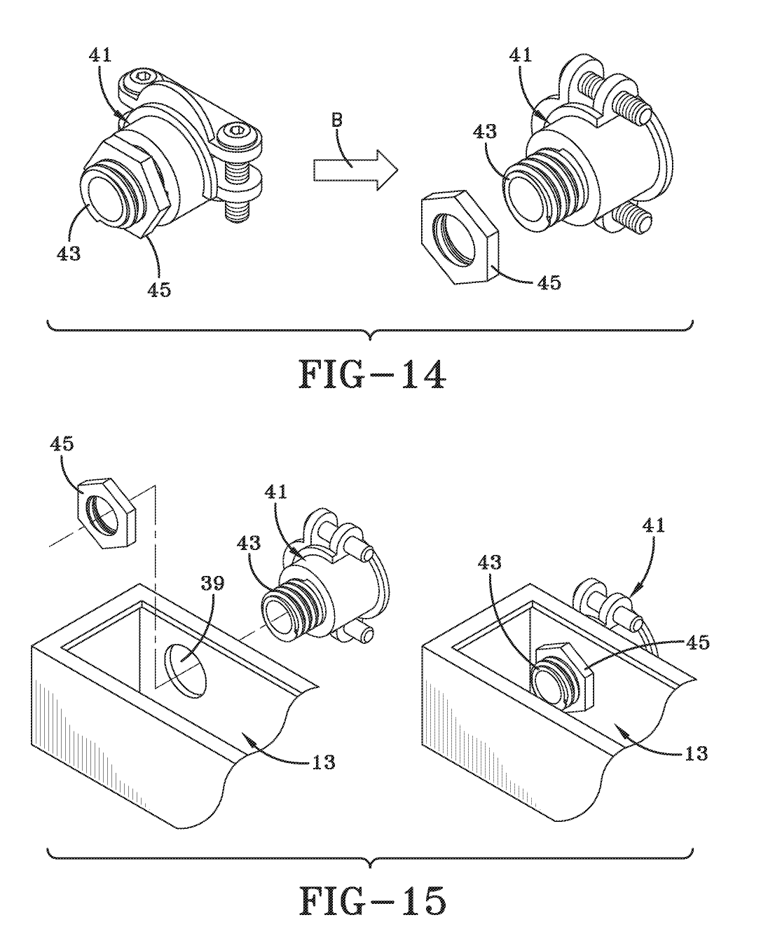

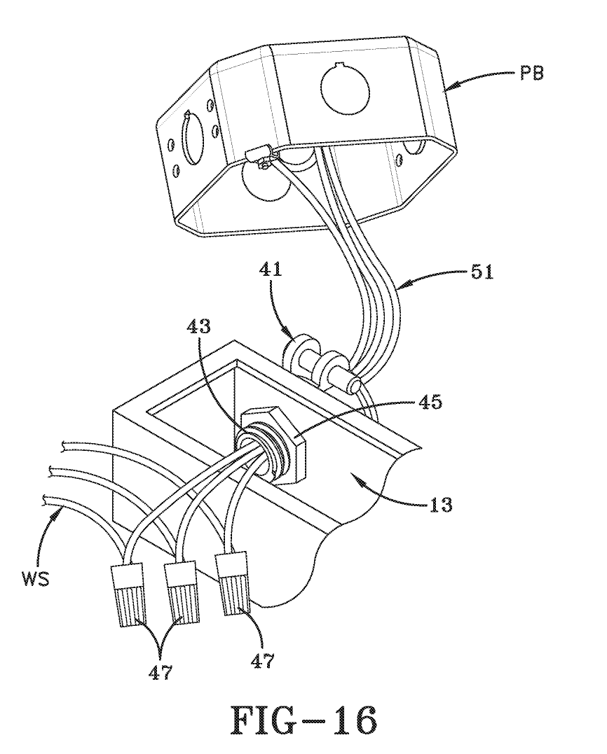

It is also possible to make direct wire power connections of LED wall fixture L as indicated in FIGS. 12-16. Back plate 13 has opposing pairs of screws 37. Screws 37 are removed from LED light fixture L and back plate 13 is then removed from LED light fixture L. Back plate 13 has three knock-out holes 39 (the same identification number 39 is used before or after the portion filling in the hole is present or has been removed). The person making the direct wire power connection determines which knock-out hole 39 in back plate 13 is closest to the power supply wire feed, and that particular knock-out hole 39 is removed. A strain relief 41 (FIGS. 14-16) includes a threaded end 43. A nut 45 is removed from threaded end 43 as indicated by arrow B. Threaded end 43 is inserted through the particular knock-out hole 39 from the outside of the unit as shown in FIG. 15. A flexible whip or NM cable 51 for the power supply is fed through strain relief 41 in back plate 13, and a clamp is tightened until it is secure.

Thereafter, the hot and neutral wires WS from a power supply box PB to the appropriate wires from an electric box. The wire from the power supply box PB is connected to the grounding wire from the electric box. The wire connections are covered using wire connectors 47 and electrical tape. All of the wire connections into the wire compartment in LED light fixture L are tucked into the wire compartment in LED light fixture L, and back plate 13 is reattached to LED light fixture L with four screws 37 previously removed. A toggle switch 49, shown in FIG. 8, is used to turn LED lamps fixture L on and off.

LED light fixture L is preferably an LED elongated light fixture. The embodiment of the invention could be modified for the installation of an elongated under-cabinet LED light, and could also be modified for LED puck lights.

Not only is under-cabinet LED light fixture L easy to install, but when the magnetic attraction is used it can be adjusted at ease by hand, and can be easily removed manually as well. One can easily adjust the position of the LED light fixture by a mere push of one's hand against the LED light fixture L to slide it along underside 7 of mounting plate 3, and LED light fixture L can be removed by simply pulling LED light fixture L away from underside 7 of mounting plate 3.

Mounting plate 3 can be configured according to the configuration of LED light fixture L. Thus, for example, if LED light fixture L was a puck LED light having a circular surface to be adhered to the mounting plate, mounting plate 3 could have a circular configuration. The length and width of mounting plate 3 could vary to be of proper dimensions to hold a particular LED light fixture L in place.

The invention has been described in detail with particular reference to the preferred embodiment thereof, variations and modifications within the spirit and scope of the claims are understood by those skilled in the art to which the invention pertains.

1. A mounting assembly for attaching an under-cabinet LED light fixture to an under-cabinet, the under-cabinet including a horizontal wall with an underside, said mounting assembly comprising:
a ferromagnetic mounting structure being attachable to a selected one of the group consisting of the underside of the horizontal wall of the under-cabinet and the under-cabinet LED light fixture; and
at least one magnet attached to the other of the underside of the horizontal wall of the under-cabinet and the said under-cabinet LED light fixture;
said at least one magnet being magnetically attracted to said ferromagnetic mounting structure to attach said under-cabinet LED light fixture to the horizontal wall of the under-cabinet.

2. The mounting assembly for attaching an under-cabinet LED light fixture to an under-cabinet according to claim 1:
wherein said under-cabinet LED light fixture includes a topside;
wherein said ferromagnetic mounting structure is attachable to the underside of the horizontal wall of the under-cabinet; and
wherein said at least one magnet is attached to said topside of said under-cabinet LED light fixture.

3. The mounting assembly for attaching an under-cabinet LED light fixture to an under-cabinet according to claim 2 and further comprising a back plate, said back plate constituting the topside of said under-cabinet, wherein said at least one magnet is attached to said back plate.

4. The mounting assembly for attaching an under-cabinet LED fixture to an under-cabinet according to claim 2 wherein said ferromagnetic mounting structure includes attachments for attaching said mounting structure to the horizontal wall of the under-cabinet.

5. The mounting structure according to claim 2 wherein said ferromagnetic mounting structure comprises an LED light fixture engaging surface, said LED light fixture engaging surface being configured to match the shape of the LED light fixture to enable the LED light fixture to engage said LED light fixture engaging surface in a superimposed matching relationship.

6. A mounting assembly for attaching an under-cabinet LED light fixture to an under-cabinet according to claim 2 wherein said under-cabinet LED light fixture is an elongated under-cabinet LED light fixture, wherein said topside is ferromagnetic, and wherein said at least one magnet is attached to said ferromagnetic topside.

7. The mounting assembly for attaching an under-cabinet LED light fixture to an under-cabinet according to claim 6 and further comprising a back plate forming the topside of said under-cabinet LED light fixture.

8. The mounting assembly for attaching an under-cabinet LED light fixture to an under-cabinet according to claim 2 wherein said ferromagnetic mounting structure comprises a mounting plate.

9. The mounting assembly for attaching an under-cabinet LED light fixture to an under-cabinet according to claim 1, wherein said under-cabinet LED light fixture is attachable with mechanical fasteners directly to the underside of the horizontal wall of the under-cabinet.

10. The mounting assembly for attaching an under-cabinet LED light fixture to an under-cabinet according to claim 7 wherein said at least one magnet is attached to said back plate.

11. The mounting assembly for attaching an under-cabinet LED light fixture to an under-cabinet according to claim 1 wherein the magnetic attraction between said ferromagnetic mounting structure and said under-cabinet LED light fixture enables the manual adjustment of said under-cabinet LED light fixture relative to said magnetic mounting within the attraction range of said magnetic attraction.

12. A mounting assembly for attaching an under-cabinet LED light fixture to an under-cabinet wherein said under-cabinet LED light fixture, wherein said mounting assembly comprises:
a ferromagnetic back plate attached to said under-cabinet LED light fixture;
at least one magnet is attached to said back plate; and
a ferromagnetic mounting plate attached to the underside of said under-cabinet;
wherein the magnetic force of said at least one magnet attaches said under-cabinet LED light fixture to said underside of said horizontal wall.

13. The mounting assembly for attaching an under-cabinet LED light fixture to an under-cabinet according to claim 12 wherein said at least one magnet comprises at least two magnets attached to said back plate.
